(19) United States
(12) Patent Application Publication
(10) Pub. No.: US 2009/0197050 A1
(43) Pub. Date: Aug. 6, 2009

(54) METHOD OF MANUFACTURING COMPOSITE PART

(75) Inventor: Jago Pridie, Bristol (GB)

Correspondence Address: LOWE HAUPTMAN HAM & BERNER, LLP, 1700 DIAGONAL ROAD, SUITE 300, ALEXANDRIA, VA, 22314, US

(73) Assignee: AIRBUS UK LIMITED, Bristol (UK)

(21) Appl. No.: 12/303,422

(22) PCT Filed: Jul. 11, 2007
(86) PCT No.: PCT/GB2007/050394

§ 371 Date: Dec. 4, 2008

(30) Foreign Application Priority Data
Jul. 12, 2006 (GB) 0613872.1

(51) Int. Cl. B29C 59/02; B32B 1/00

(52) U.S. Cl. 428/174; 264/292; 264/101; 264/320; 264/241

(57) ABSTRACT

A method of manufacturing a composite part, the method comprising: placing a charge on a male tool having a convex surface region; debulking the charge on the male tool by applying pressure to the charge, the applied pressure varying over the surface of the charge so as to be intensified where the charge engages the convex surface region of the male tool; and curing the charge on a female tool having a concave surface region. The charge is formed and debulked in a series of stages to form a laminate. The charge is formed at a first temperature T1; debulked at a second temperature T2; and cured at a third temperature T3, wherein T1<T2<T3.

### RELATED APPLICATIONS

The present application is based on International Application Number PCT/GB2007/050394 filed Jul. 11, 2007, and claims priority from British Application Number 0613872.1 filed Jul. 12, 2006, the disclosures of which are hereby incorporated by reference herein in their entirety.

### FIELD OF THE INVENTION

The present invention relates to a method of manufacturing a composite part.

### BACKGROUND OF THE INVENTION

It is well known that composite parts reduce in thickness during cure. This process is known as “debulking”, and is almost entirely due to the release of entrapped air. Typically the reduction in thickness of a pre-impregnated laminate (commonly known as a “prepreg”) is of the order of 10-15%, and for a dry fabric composite the reduction can be even greater. This can become a significant problem when either:
a) the part is of a significant thickness (typically >10 mm) and is at least partly non-planar; or
b) the part incorporates padup areas a lot thicker than that of the surrounding material.

FIG. 1 illustrates a problem where the part is of a significant thickness and is at least partly non-planar. A charge 1 is placed in a female mould 2, and heated to cure the composite material. Debulking occurs uniformly in the planar regions of the charge, but in the concave corner regions the carbon fibres (being unable to stretch significantly) tend to bridge across the corner as shown by dotted lines 5,6. This results in porosity and failure to meet required geometric tolerances in the corner regions.

A conventional approach to this problem is described in US2006/0017200, in which a pressing device is used to compress the charge locally in the concave corner regions of the female tool.

A method of moulding an article by stretching a membrane over a moulding tool is described in U.S. Pat. No. 6,723,272.

### SUMMARY OF THE INVENTION

A first aspect of the invention provides a method of manufacturing a composite part, the method comprising:
placing a charge on a male tool having a convex surface region;
debulking the charge on the male tool by applying pressure to the charge, the applied pressure varying over the surface of the charge so as to be intensified where the charge engages the convex surface region of the male tool; and
curing the charge on a female tool having a concave surface region.

The first aspect of the invention recognises that debulking can be more easily intensified on a male tool, compared to the female tool described in US2006/0017200 which requires a complex pressing device to access the concave corner regions of the tool. Debulking and curing the charge on different tools enables the tools to be designed for optimal performance.

The pressure may be applied to the charge in a number of ways, including applying direct pressure using a rigid pressing device, placing a membrane against the charge and increasing the pressure on one side of the membrane, and/or placing a membrane against the charge and evacuating a cavity between the charge and the membrane.

The pressure may be intensified by a rigid pressing device which presses the charge where it engages the convex corner region of the male tool. However in a preferred embodiment the pressure is intensified by stretching a resilient membrane over the charge where it engages the convex corner region of the male tool. Typically the resilient membrane is stretched by providing a channel adjacent to the male tool and bridging the membrane over the channel. The inventor has recognized that a resilient membrane can be used to apply a non-uniform pressure: that is, a pressure which varies over the surface of the charge and is more intense in the convex surface region. This possibility is not recognised in U.S. Pat. No. 6,723,272.

The convex surface region of the male tool may be curved or formed by a series of flat surfaces. Preferably the male tool comprise a pair of convex surface regions separated by a region which is less convex (for instance, it may be substantially planar, or concave). In this case the applied pressure is greater in the convex surface regions than in the less convex region.

The charge may be pre-formed: that is, it may be shaped on a forming tool before being placed on the male tool. However preferably the method further comprises shaping and debulking the charge on the male tool. This enables a single tool to be used for both shaping and debulking. Preferably shaping is carried out prior to debulking, and at a lower temperature. Alternatively, instead of shaping the charge by utilising a forming process applied to a planar charge, the preform may be manufactured by hand laying a series of plies onto the male tool, each ply conforming to the shape of the tool as it is laid.

In one embodiment the method further comprises: laying a set of one or more plies of material on the debulked charge to form a laminate; and debulking the laminate before the curing step. It has been found that by debulking a laminate in a series of stages, improved debulking results are achieved. The laying and debulking steps may be repeated a number of times to form a laminate of desired thickness.

Typically the charge or laminate is heated during debulking. Preferably, the method further comprises: shaping the charge on the male tool at a first temperature T1; heating and debulking the charge on the male tool at a second temperature T2; and curing the debulked charge at a third temperature T3, wherein T1<T2<T3. By shaping and debulking the charge at relatively low temperatures (compared with the curing temperature T3) any thermal history effects on the material (which may for instance advance the level of cure of the charge) are reduced as well as reducing energy costs. Also, debulking at a relatively high temperature (compared with the forming temperature T1) gives improved debulking results.

The composite part may be formed from any suitable composite material. In the preferred embodiments described below, the charge (or the laminate) is typically a prepreg material made from resin reinforced with either uniaxial or woven carbon fibre. However in alternative embodiments the composite material may manufactured in other ways. For example the charge (or the laminate) may be in a dry fibre form, such as a non-crimped fabric comprising multi-axial dry fibres which may have a binder applied to its surface before debulking to enable the manufacture of a debulked dry fibre preform. This dry fibre perform will then be vacuum infused or injected with a liquid resin using techniques such as RIFT (vacuum infusion) or RTM (injection) to create the composite part. This infusion/injection step is preferably performed at the same temperature as the minimum viscosity, which is normally lower than the cure temperature. Thus the infusion/injection step may be performed on the curing tool as the charge is brought up to cure temperature, or in a separate heating/cooling cycle. Alternatively, non-bindered dry fibre plies are interleaved with layers of resin film to form a resin film infused (RFI) laminate. When the charge is heated during debulking, the resin films flow and impregnate the fibre layers. This type of material is preferred in some applications because it is quicker to lay (typically 0.75 mm per ply compared with 0.2 mm per ply in a prepreg). Although the mechanical properties of RFI composite parts suffer reduced mechanical performance when compared with prepreg, they have improved mechanical properties when compared to liquid resin technologies such as RTM. Bulk factors are typically higher than in prepregs.

In the preferred embodiments described below, the composite part comprises a spar of an aircraft wing. However the invention may be used to form a variety of other aircraft parts (such as stringers), or parts of other composite structures for (for example) boats, automobiles etc.

### BRIEF DESCRIPTION OF THE DRAWINGS

Embodiments of the invention will now be described with reference to the accompanying drawings, in which:

FIG. 1 illustrates a problem with conventional curing methods;

FIG. 2 shows a planar charge prior to forming;

FIG. 3 shows a forming process;

FIG. 4a shows a set of consumables added to the charge after forming;

FIG. 4b shows a debulking arrangement;

FIG. 5 shows movement of the diaphragm during debulking;

FIG. 6 shows the final position of the diaphragm during debulking;

FIG. 7 shows the difference in thickness of the charge before and after debulking;

FIG. 8 shows a curing arrangement;

FIG. 9 shows an alternative double diaphragm forming and debulking arrangement; and

FIG. 10 shows an alternative arrangement of sweeper blocks.

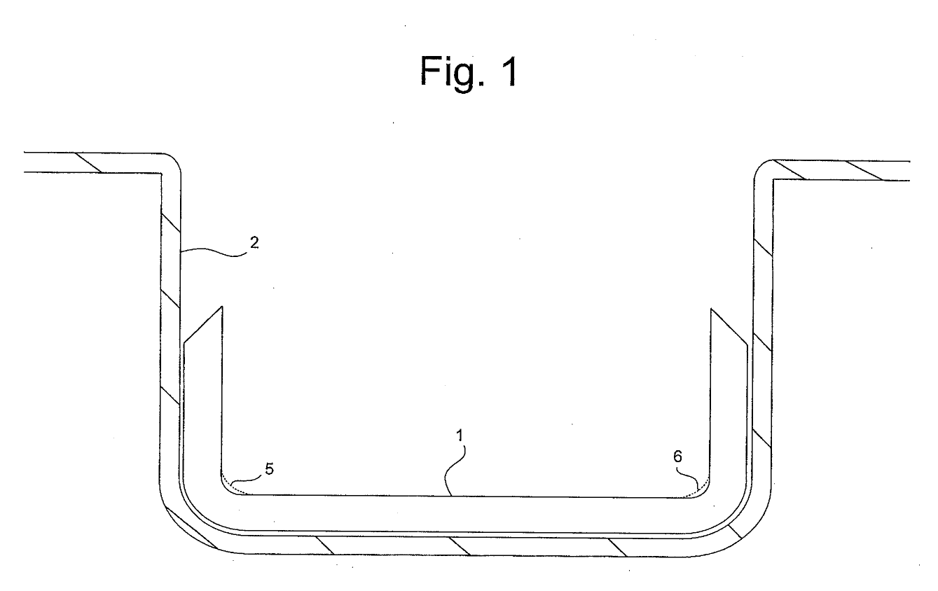

### DETAILED DESCRIPTION OF EMBODIMENT(S)

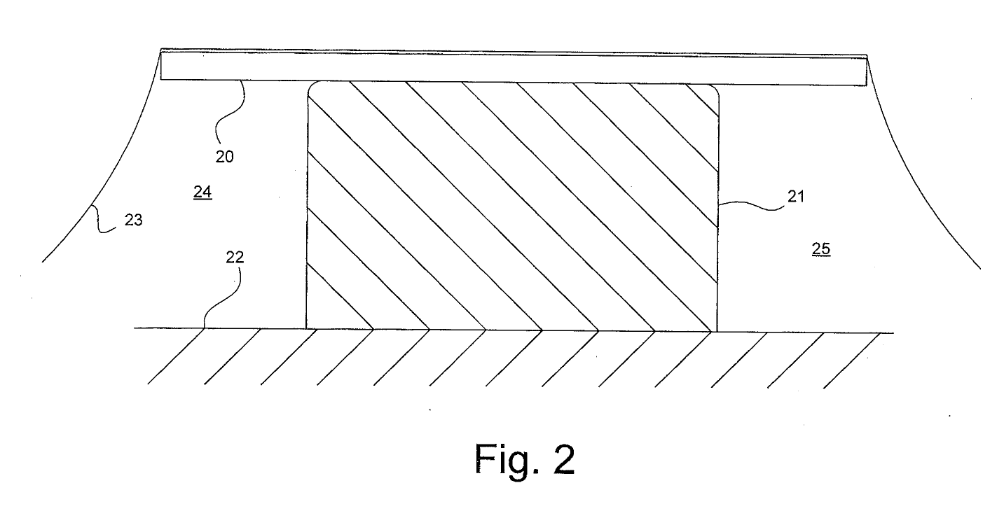

FIGS. 2-7 show a method of manufacturing a C-section aircraft spar.

In a first step, a planar sheet of composite prepreg is formed either by a tape-laying or other automated machine on a planar table (not shown). A planar prepreg charge 20 with the desired shape is then cut from the planar sheet. The planar prepreg charge 20 is placed on a male moulding and debulking tool 21 on a table 22 as shown in FIG. 2. It will be appreciated that the prepreg charge 20 may be formed from a variety of suitable composite materials. In a preferred embodiment the charge is formed from an epoxy resin reinforced by uniaxial carbon fibres, such as T700/M21 manufactured provided by Hexcel (www.hexcel.com).

A resilient diaphragm 23 is placed over the charge 20 and fixed to the table 22 (by means not shown). It will be appreciated that the diaphragm 23 may be formed from a variety of suitable resilient materials. In a preferred embodiment the diaphragm is made of silicone rubber manufactured by the Mosite Rubber Company of Fort Worth, Tex.

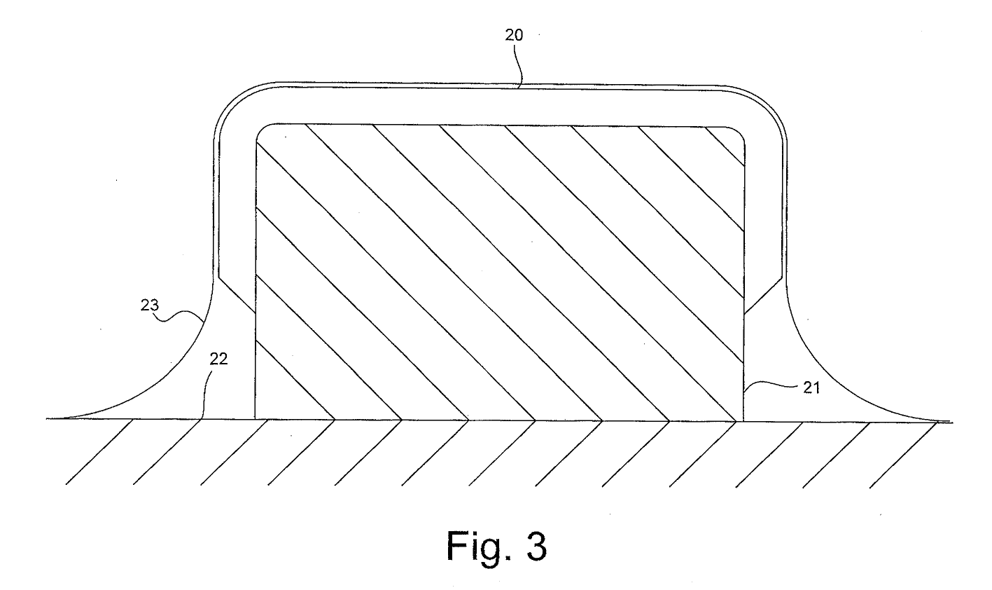

Pressure is applied to the charge 20 by evacuating the cavities 24,25 between the table 22 and the diaphragm. This vacuum may be applied via one or more ports (not shown) in the diaphragm 23 or one or more ports (not shown) in the table 22. This pressure, along with an increased temperature T1 of 70° C.-90° C. (preferably 75° C.) causes the charge 20 to be shaped to conform to the spar Inner Mould Line (IML) geometry as shown in FIG. 3. The charge is held at the desired temperature T1 and then cooled.

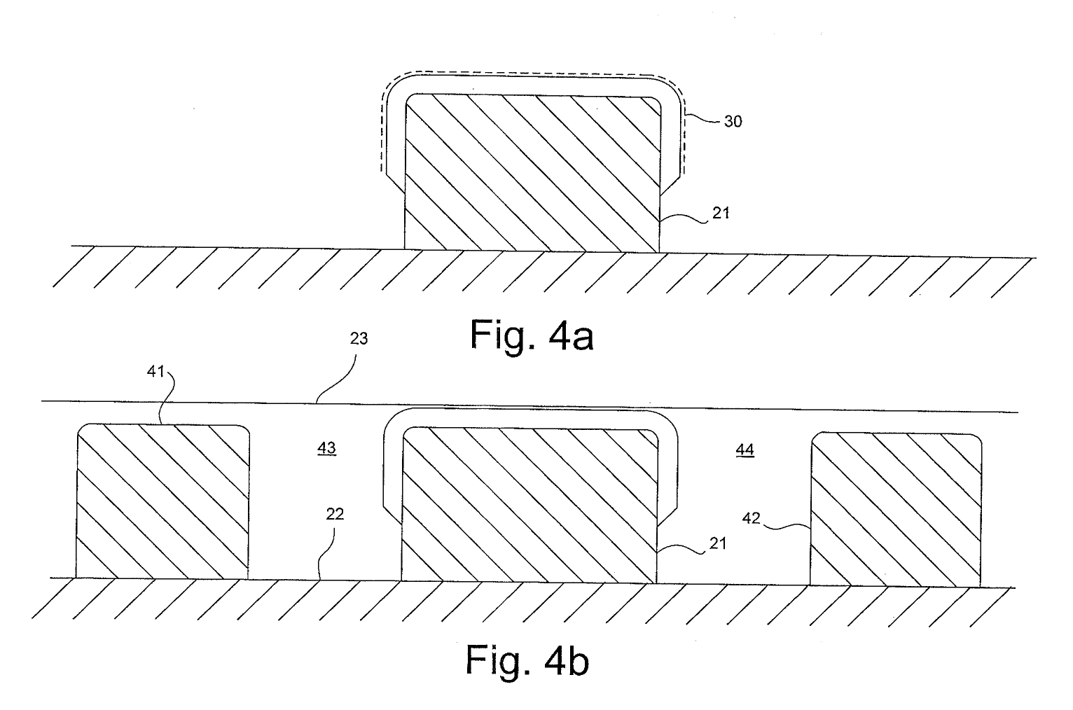

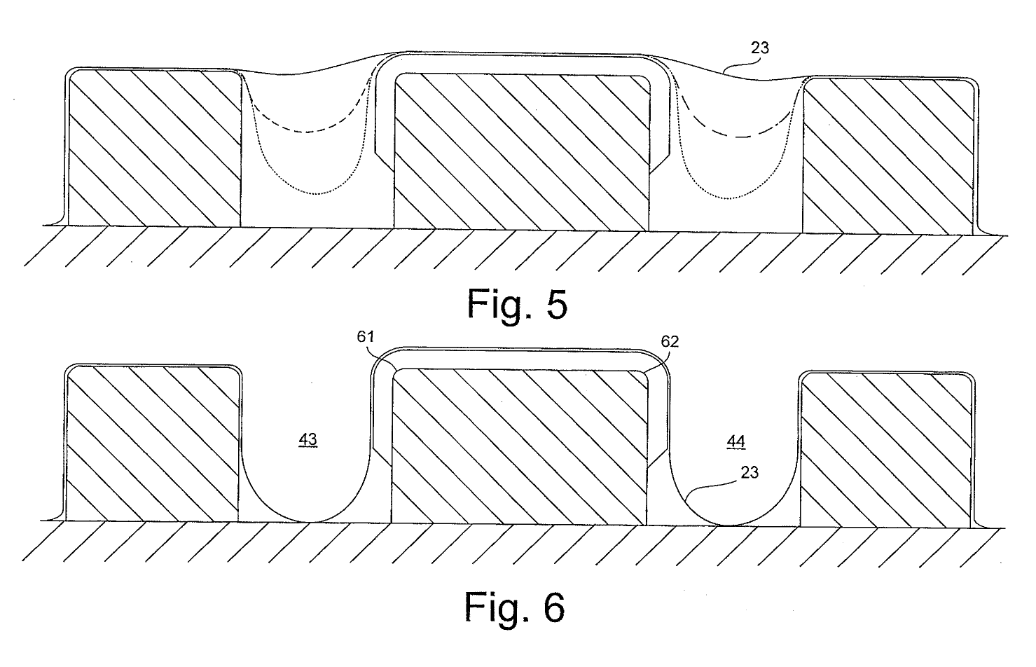

The diaphragm 23 is then removed and a pair of sweeper blocks 41,42 positioned on either side of the tool 21 as shown in FIG. 4b. The sweeper blocks are located to provide channels 43,44 with a width approximately equal to their height.

A set of consumables 30 shown in FIG. 4a is then applied to the charge. The consumables 30 may be for instance a perforated release film (such as fluorinated ethylene-propylene) in direct contact with the charge; a peel ply on top such as peel ply ‘G’ (available from Tygavac Advanced Materials Ltd, of Rochdale United Kingdom) followed by a breather layer such as UW606 (also available from Tygavac Advanced Materials Ltd).

Note that the consumables 30 remain in place during the hot debulking process described below with reference to FIGS. 4b-7, but are omitted from these Figures for the purposes of clarity. The consumables 30 allow any entrapped air and volatiles to escape during the hot debulking process.

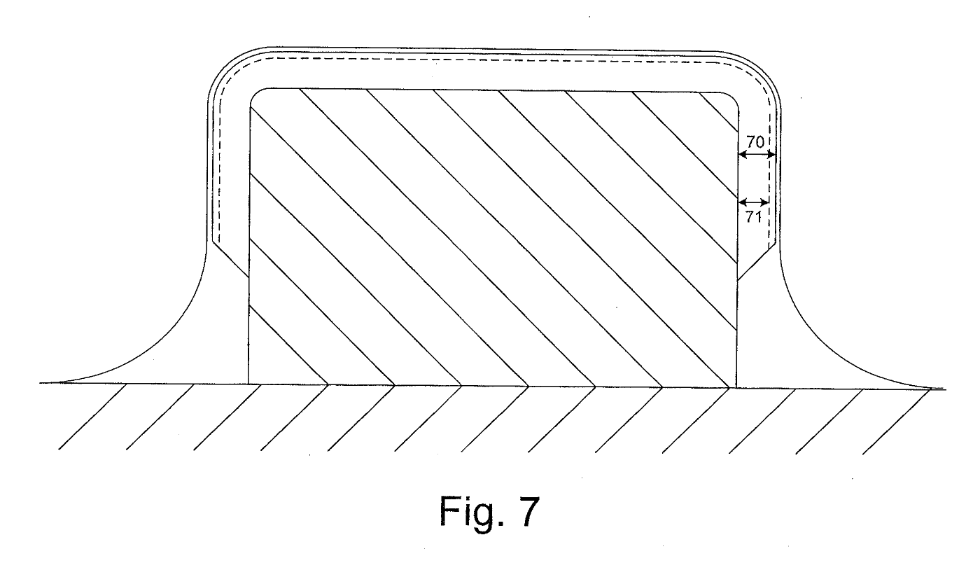

The diaphragm 23 is then draped over the tool and sweeper blocks 41,42 as shown in FIG. 4b. The assembly is then brought up to a temperature T2 of 85° C.-95° C. (preferably 90° C.) and held at the temperature T2 for the debulking period. It has been found that the debulking temperature T2 is preferably greater than the forming temperature T1. Heat may be applied during debulking by an oven, infrared heating element, or any other means. A vacuum is applied between the diaphragm 23 and the table 22, which causes the diaphragm to gradually form the shape shown in FIG. 6 via a number of intermediate positions shown in dashed and dotted lines in FIG. 5. Optionally, additional debulking pressure may be provided by placing the assembly in an autoclave and applying pressure above 1 bar to the outer side of the diaphragm 23.

The pressure difference across the diaphragm imparts a uniform hydrostatic pressure on all areas of the charge. The bridging of the diaphragm 23 over the channels 43,44 causes the diaphragm to stretch, giving a stretching force in the plane of the diaphragm which is reacted by the charge where it engages the convex surface regions of the male tool (that is, at the corners 61,62). Thus the debulking pressure applied to the charge varies over its surface between a pure hydrostatic pressure (up to atmospheric pressure, or beyond if an autoclave is used) where it engages the less convex approximately planar surface regions on the top and sides of the tool, and an intensified pressure at the convex corners 61,62 comprising the stretching pressure added to the hydrostatic pressure.

Debulking of the charge is caused by the combination of pressure and increased temperature during the debulking stage. Debulking is also assisted by the action of the diaphragm 23 which gradually moves down the vertical arm of the charge through the intermediate positions shown in FIG. 5, squeezing excess air out of the charge.

FIG. 7 shows the outer profile of the charge prior to debulk in solid lines, and after debulk in dashed lines. The debulking process reduces the thickness of the charge from a thickness 70 prior to debulk to a thickness 71 after debulk. Note that the thickness has reduced by a similar amount in both the non-planar and planar regions of the charge. In one embodiment the thickness 70 is about 34 mm and the thickness 71 is about 30 mm.

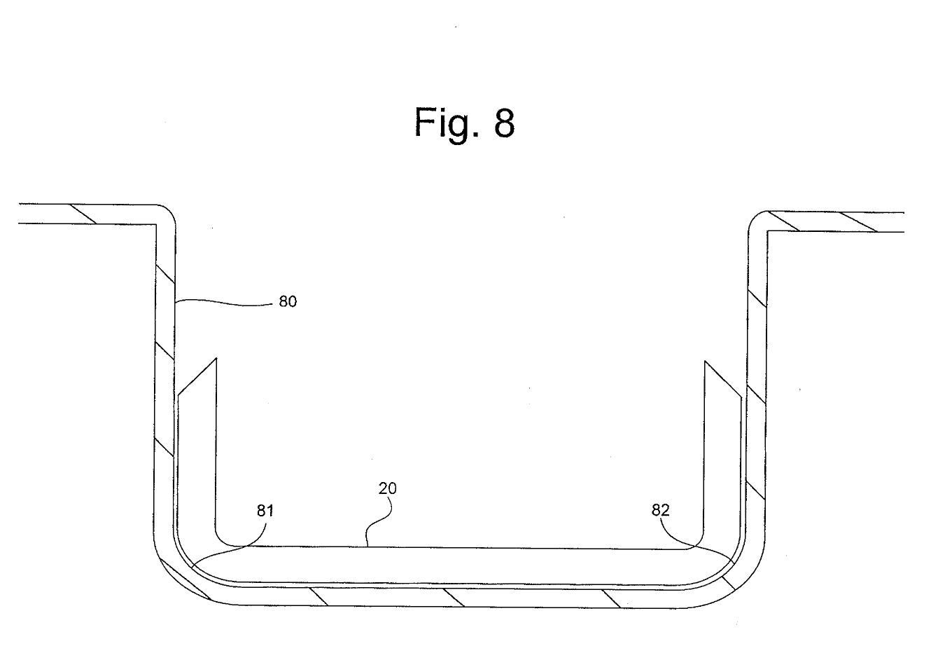

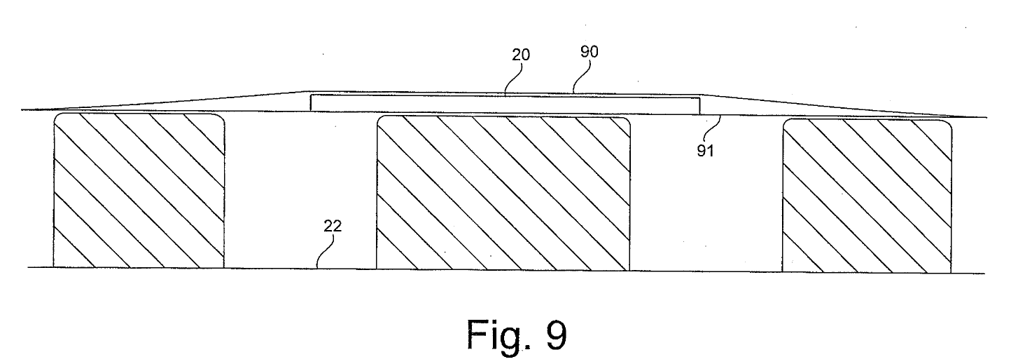

After debulking, the consumables 30 are removed, the debulked charge 20 is transferred to a female curing tool 80 shown in FIG. 8, and relevant consumables applied to the IML of the charge 20. The tool 80 is then placed in an autoclave where it is heated to a temperature T3 of approximately 180° C. and pressurised to approximately 7 bar to cure the charge.

The charge on the female curing tool 80 is net thickness, which means that the IML surface of the charge does not have to move on cure. Therefore the thickness of the charge remains constant in the non-planar regions where the charge engages the convex corner surfaces 82,82 of the tool.

In an alternative process, instead of curing the charge on a female tool 80 as shown in FIG. 8, the charge may be cured on the male tool 21 which is used for moulding and debulking. In this case, sacrificial plies may be added to the Outer Mould line (OML) of the charge for machining in order to meet geometric tolerances. The hot debulking process controls the thickness of the male cured spar, and thus variability in the part is reduced and the thickness (or number) of sacrificial plies required is minimised.

An alternative to the single-diaphragm moulding and debulking processes shown in FIGS. 2-7 is shown in FIG. 9. In this case, instead of using a single diaphragm 23, the charge 20 is received between a pair of diaphragms 90,91. During moulding and debulking, the cavity between the diaphragms 90,91 is evacuated, as well as the cavity between the lower diaphragm 91 and the table 22. The diaphragms place the charge in tension, making it easier to mould the charge over ramps or other complex shapes on the male tool.

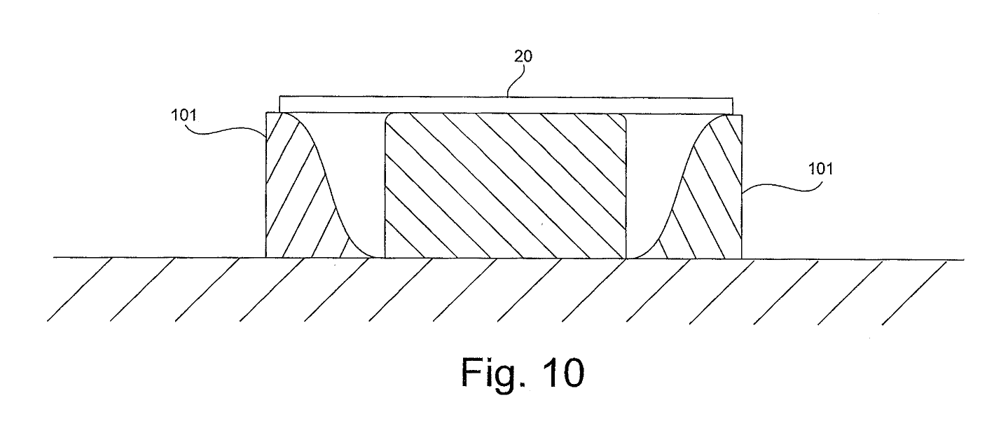

An alternative set of sweeper blocks is shown in FIG. 10. In this case, the vertical-sided sweeper blocks 41,42 are replaced by sweeper blocks 100,101 with angled and curved side walls which engage the edge of the charge 20 as it is formed.

The processes described above involve only a single forming stage (FIG. 3) and a single debulking stage (FIG. 6). However in an alternative embodiment, the forming and debulking stages may be repeated to build up a laminate of increasing thickness. Thus the process in this case will proceed as follows:
1. mould a charge 20 (as in FIG. 3), typically with 20-30 plies;
2. add consumables
3. debulk the charge (as in FIG. 6);
4. remove the consumables;
5. lay a further planar prepreg charge, typically with 20-30 plies, on the moulded and debulked charge on the male tool 21;
6. mould the further planar prepreg on the male tool 21 to form a laminate of increased thickness;
7. add consumables;
8. debulk the laminate;
9. repeat steps 4-8 as many times as required to build up the required total thickness of laminate; and then
10. cure the laminate.

Typically the required total thickness of laminate is up to 100 plies, so the laminate is formed in up to five debulking steps.

In the embodiments above, the sweeper blocks 41,42 (or 100,101) are introduced after the forming step shown in FIG. 3. However, the sweeper blocks may also be used in the forming step as well as the debulking step.

Although the invention has been described above with reference to one or more preferred embodiments, it will be appreciated that various changes or modifications may be made without departing from the scope of the invention as defined in the appended claims.

1. A method of manufacturing a composite part, the method comprising:
placing a charge on a male tool having a convex surface region;
debulking the charge on the male tool by applying pressure to the charge, the applied pressure varying over the surface of the charge so as to be intensified where the charge engages the convex surface region of the male tool; and
curing the charge on a female tool having a concave surface region.

2. The method of claim 1 wherein the male tool comprise a pair of convex surface regions separated by a region which is less convex, and wherein the applied pressure is greater in the convex surface regions than in the less convex region.

3. The method of claim 1 wherein the pressure is intensified by stretching a resilient membrane over the charge where it engages the convex region(s) of the male tool.

4. The method of claim 3 wherein the resilient membrane is stretched by providing a channel adjacent to the debulking tool and bridging the membrane over the channel.

5. The method of claim 1 wherein the convex surface region of the male tool is curved.

6. The method of claim 1 wherein the pressure is applied to the charge by placing a membrane against the charge and evacuating a cavity between the charge and the membrane.

7. The method of claim 1 further comprising shaping the charge on the male tool.

8. The method of claim 1 further comprising:
laying a set of one or more plies of material on the debulked charge to form a laminate; and
debulking the laminate before the curing step.

9. The method of claim 1 further comprising applying heat during debulking.

10. The method of claim 9 further comprising:
shaping the charge on the male tool at a first temperature T1;
heating and debulking the charge on the male tool at a second temperature T2; and
curing the debulked charge at a third temperature T3,
wherein T1<T2<T3.

11. (canceled)

12. (canceled)

13. (canceled)

14. The method of claim 1 wherein the composite part is an aircraft part.

15. A composite part manufactured by the method of claim 1.
